(19) United States
(12) Patent Application Publication
(10) Pub. No.: US 2026/0219856 A1
(43) Pub. Date: Jul. 30, 2026

(54) Processor Environment Agnostic Firmware Management Operation Including a Firmware Component Management Operation

(71) Applicant: Dell Products L.P., Round Rock, TX (US)

(72) Inventors: Gowrishankar Rudraprakash, Bengaluru (IN); Shekar Babu Suryanarayana, Bangalore (IN); Karunakar Poosapalli, Telangana (IN)

(21) Appl. No.: 19/038,007

(22) Filed: Jan. 27, 2025

(51) Int. Cl. G06F 8/61

(52) U.S. Cl. CPC G06F 8/61

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a firmware component management operation, the firmware component management operation managing updating of a firmware component of the distributed unified BIOS with an updated firmware component.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a firmware component management operation, the firmware component management operation managing updating of a firmware component of the distributed unified BIOS with an updated firmware component.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments; performing a firmware component management operation, the firmware component management operation managing updating of a firmware component of the distributed unified BIOS with an updated firmware component.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments; performing a firmware component management operation, the firmware component management operation managing updating of a firmware component of the distributed unified BIOS with an updated firmware component.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of Authenticated Basic Input/Output System (BIOS) Interface (ABI) services implemented within a cloud computing environment;

FIG. 6 is a simplified process flow diagram of Cloud-based Authenticated Basic Input/Output System (BIOS) Authenticated Services (CAS) implemented to insert a trusted firmware component into a boot path;

FIGS. 7a and 7b are a simplified process flow diagram showing the performance of certain firmware component management (FCM) operations to enable the provision of a persistent firmware component update; and

FIG. 8 is a simplified process flow diagram showing the performance of certain FCM operations to enable the provision of a non-persistent firmware component update

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that there is currently no known System on Chip (SoC) agnostic approach for updating an individual firmware component without writing a complete firmware update into Serial Peripheral Interface (SPI) flash memory. Examples of such firmware components include those commonly associated with processor and chipset code, third party firmware for peripheral devices, and so forth. Likewise, various aspects of the invention reflect an appreciation that no approach is currently known for securely providing an individual firmware component during operating system (OS) runtime to update a corresponding firmware component for subsequent use during a pre-boot phase without introducing an associated security vulnerability.

Various aspects of the invention likewise reflect an appreciation that United Extensible Firmware Interface (UEFI) driver services, as typically implemented, lack the ability to dynamically identify an individual firmware component within SPI flash memory that may vulnerable. Furthermore, UEFI driver services currently lack the ability to avoid damaging certain boot firmware components that may be vulnerable by suppressing the loading of an unsafe firmware component into the boot path. Moreover, UEFI driver services currently lack the ability to load a safe firmware component it may receive in place of a vulnerable, or otherwise faulty, firmware component.

Likewise, various aspects of the invention reflect an appreciation that firmware downgrade restrictions, as typically implemented, restrict roll-backs to prior versions if a firmware bug is introduced subsequent to a firmware update. As a result, the system may not boot or exhibit other operational issues, with the only recourse being replacement of its motherboard. Various aspects of the invention likewise reflect an appreciation that such firmware component update issues may impede Self-Regulatory Organizations (SROs), such as system manufacturers and vendors, from meeting their industry compliance obligations.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

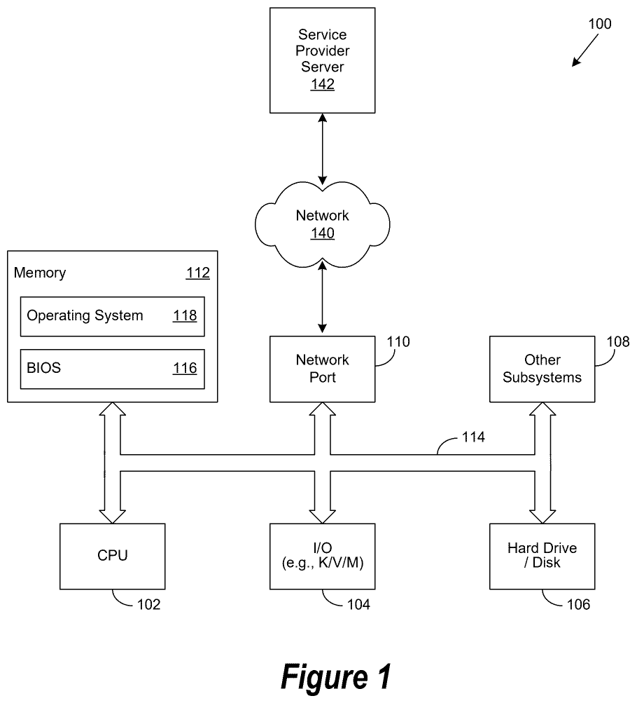

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a firmware component management operation.

A firmware component management (FCM) operation, as used herein, broadly refers to any function, task, procedure, or process performed, directly or indirectly, within a multi-processor operating environment, or an architecture-specific distributed firmware management platform (ASDFMP), both of which are described in greater detail herein, to generate, instantiate, secure, distribute, provision, authenticate, suppress, remove, implement, modify, update, replace, monitor, or manage, or a combination thereof, an individual firmware component. In various embodiments, one or more FCM operations may be performed to update a particular BIOS 116 component implemented without necessitating the update of other BIOS 116 components. In various embodiments, a digital certificate may be used in the performance of an FCM operation to prove the authenticity of a particular firmware component prior to it being used to update a corresponding firmware component. In certain embodiments, the firmware management operation may be performed during operation of an IHS 100. In various embodiments, performance of the firmware management operation may result in the realization of improved operation of an IHS 100.

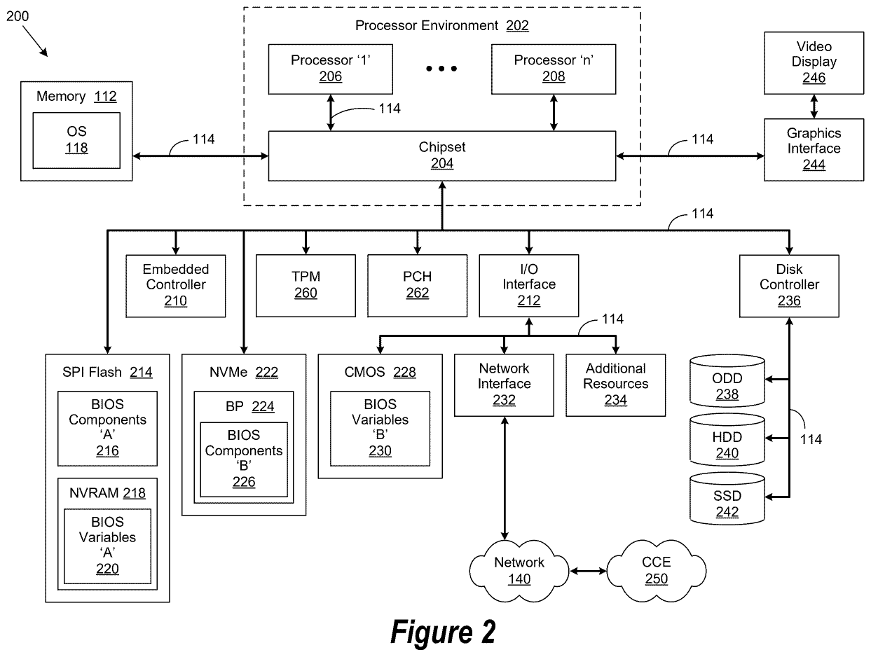

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented in a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft®Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

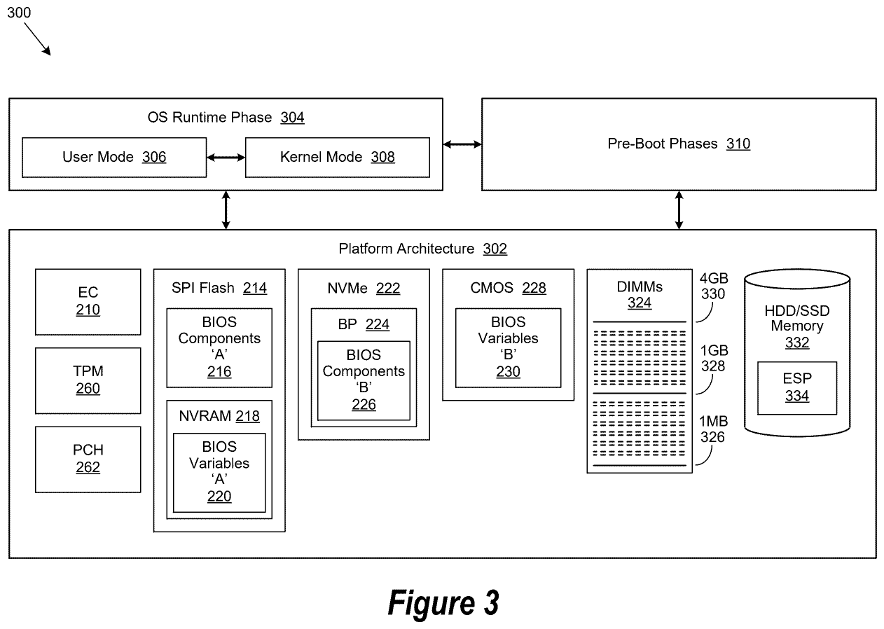

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

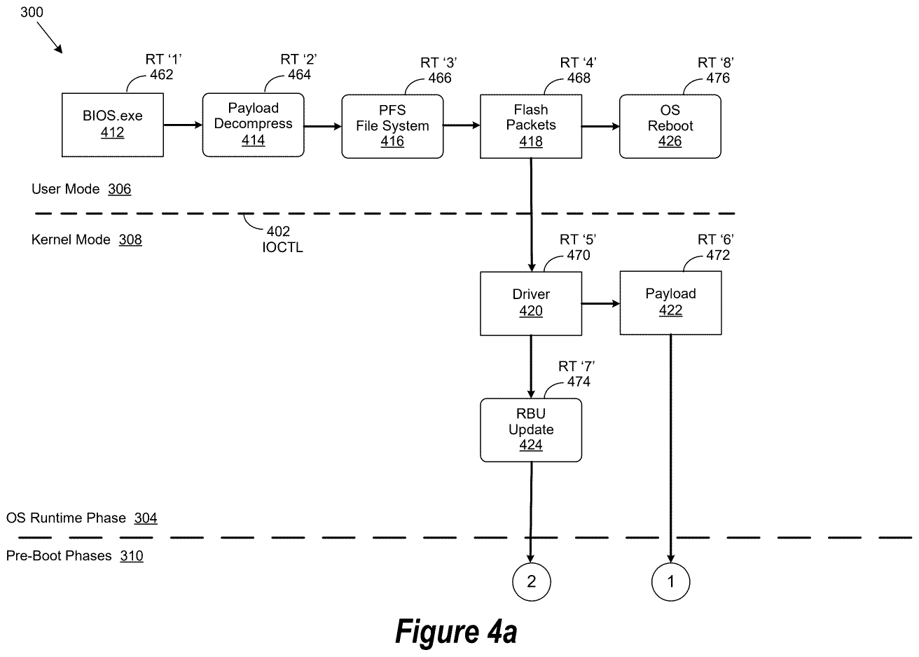

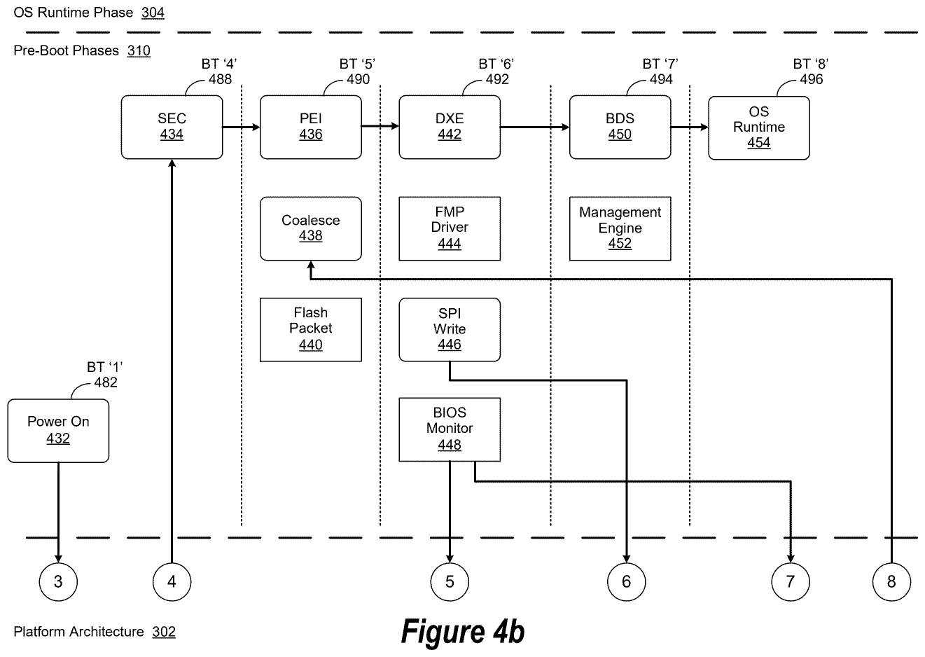

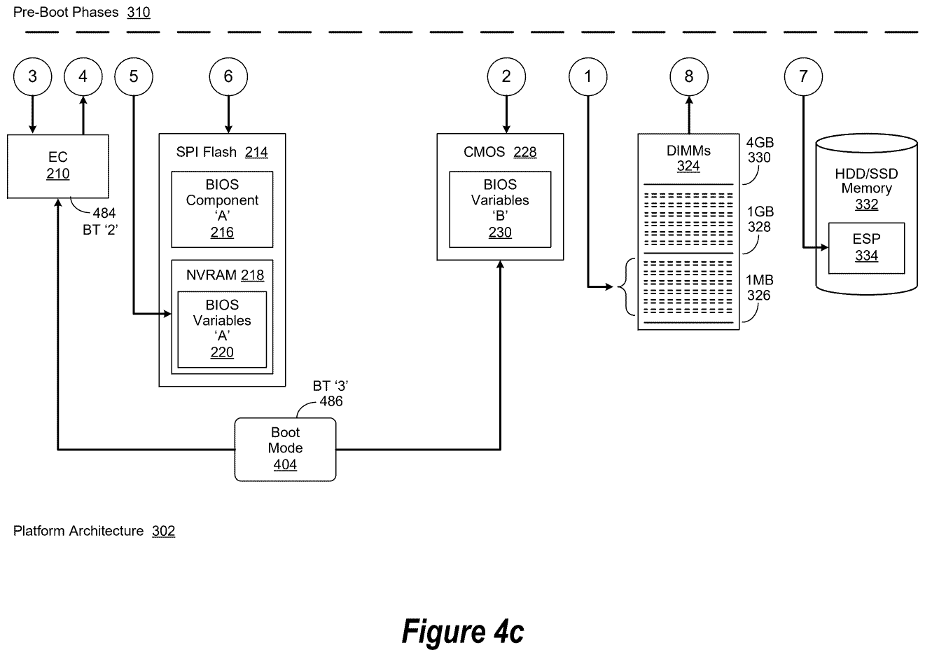

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS. exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

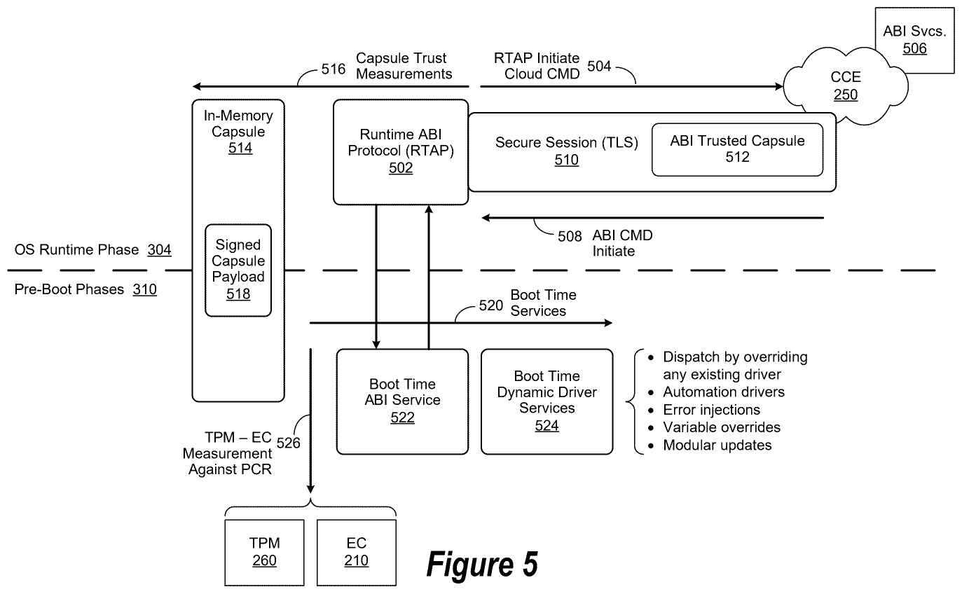

FIG. 5 is a simplified block diagram of Authenticated Basic Input/Output System (BIOS) Interface (ABI) services implemented within a cloud computing environment in accordance with an embodiment of the invention. Various embodiments of the invention reflect an appreciation that running learning models on client devices has become more common as artificial intelligence (AI) evolves. Likewise, various embodiments of the invention reflect an appreciation that large learning models (LLMs) have traditionally been deployed on powerful server infrastructures due to their extensive computational requirements.

However, various embodiments of the invention reflect an appreciation that deploying LLMs on client devices may provide certain advantages, such as a more personalized user experience, faster remediation, more immediate support, more robust data privacy, and so forth. Accordingly, an AI-capable intelligent Basic Input/Output System (BIOS), incorporating advanced algorithms and machine learning capabilities to enhance its functionality, may be implemented in various embodiments. In various embodiments, this intelligent BIOS may be implemented to autonomously detect, diagnose, and remediate issues without human intervention and provide adaptive performance and predictive maintenance.

Likewise, an eXtensible Host Controller Interface (XHCI), described in greater detail herein, may be implemented in various embodiments to improve system speed, power efficiency, and virtualization. Various embodiments of the invention likewise reflect an appreciation that typical storage capacities of portable devices have been increasing over time, with a concomitant need for high performance interfaces so they can be loaded in a reasonable amount of time. Accordingly, the implementation of an xHCI in various embodiments may reduce, or even eliminate, host memory-based transaction schedules, while its support for advanced power management features may likewise provide more power efficient platforms without sacrificing performance.

In various embodiments, the enablement of certain xHCI virtualization features may likewise allow direct assignment of individual Universal Serial Bus (USB) devices to any virtual machine (VM), irrespective of their location within a particular bus topology, to minimize run-time inter-VM communications, and provide support for native USB device sharing, or a combination thereof. Likewise, the implementation of an AI-capable intelligent BIOS in various embodiments may enable support of heterogeneous System on Chip (SoC) vendors, such as Intel®, AMD®, Qualcomm®, NVIDIA®, and so forth. The implementation of an AI-capable intelligent BIOS in various embodiments may likewise enable seamless interdependent updates services for a system's operating system (OS) and firmware. Likewise, the implementation of an intelligent cache in various embodiments may allow one or more Graphics Processing Units (GPUs), Neural Processing Units (NPUs), Accelerated Processing Units (APUs), or a combination thereof, to be leveraged to process AI workloads while supporting host embedded controller (EC) 210 side-band interrupts.

Referring now to FIG. 5, a runtime ABI protocol (RTAP) 502 may be implemented in various embodiments during a system's OS runtime phase 304. In various embodiments, the RTAP 502 may be implemented to initiate an RTAP cloud command (CMD) 504 to access certain ABI services 506, which in certain embodiments may be implemented within a cloud computing environment (CCE) 250, described in greater detail herein. In various embodiments, initiation of the RTAP cloud CMD 504 may result in certain ABI services 506 initiating an ABI CMD 508 in response.

In various embodiments, initiation of the ABI CMD 508 may result in establishing a secure session 510 between the RTAP 502 and the ABI services 506. In various embodiments, the Transport Layer Security (TLS) protocol, familiar to skilled practitioners of the art, may be used to establish the secure session 510 between the RTAP 502 and the ABI services 506. In various embodiments, the secure session 510 may be implemented to allow the ABI services 506 to provide an ABI trusted capsule 512 to the RTAP 502.

In various embodiments, the RTAP 502 may be implemented to load the ABI trusted capsule 512 into system memory as an in-memory capsule 514. In various embodiments, the RTAP 502 may likewise be implemented to perform certain capsule trust measurements 516. Likewise, the RTAP 502 may be implemented in various embodiments to generate a digitally-signed capsule payload 518.

In various embodiments, the RTAP 502 may be implemented to use the contents of the digitally-signed capsule payload 518 to create certain boot time services 520 for use during various pre-boot phases 310. In various embodiments, the boot time services 520 may include a boot time ABI service 522 and one or more boot time dynamic driver services 524. In various embodiments, the boot time ABI service 522 may be implemented to perform certain Trusted Platform Module (TPM) 260 and Embedded Controller (EC) 210 comparisons and measurements 526 against the system's Platform Configuration Register (PCR). In various embodiments the one or more boot time dynamic driver services 524 may be implemented to provide various functionalities, such as performing a dispatch by overriding any existing driver, initiating one or more automation drivers, initiating one or more error injections, performing one or more variable overrides, performing one or more modular updates, and so forth.

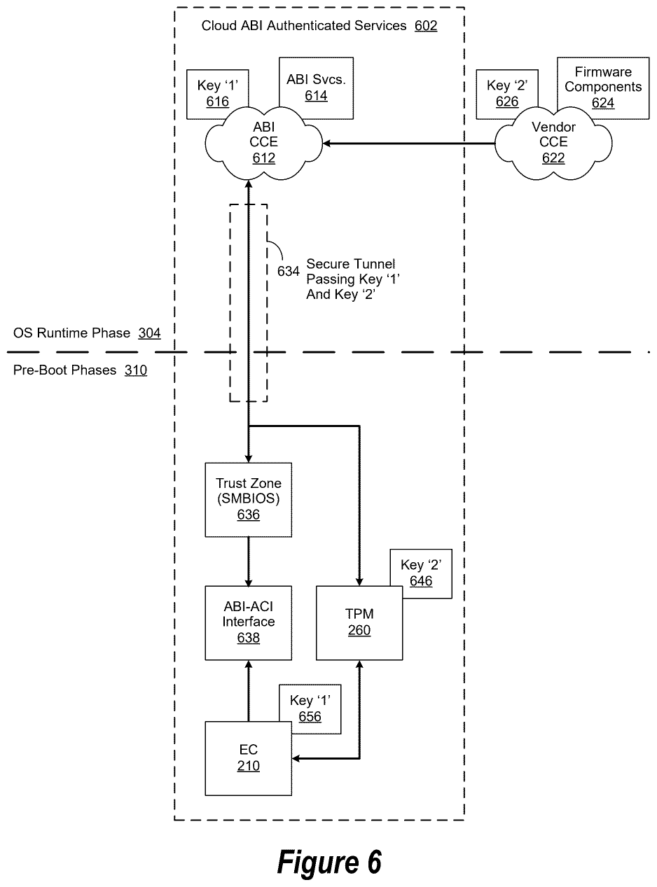

FIG. 6 is a simplified process flow diagram of certain Cloud-based Authenticated Basic Input/Output System (BIOS) Authenticated Services (CAS) implemented in accordance with an embodiment of the invention to insert a trusted firmware component into a boot path. In various embodiments, one or more CAS 602 may be implemented to provide a secure tunnel 634, familiar to skilled practitioners of the art. In various embodiments, the secure tunnel 634 may be used in certain embodiments to deliver a digitally-signed firmware component payload and associated digital certificates from one or more cloud computing environments (CCEs) 612, 622, described in greater detail herein, to a particular system.

In various embodiments, a Dynamic Driver Service (DDS) mode may be implemented to insert a trusted firmware component into a boot path. In certain of these embodiments, an embedded controller (EC) 210 may be implemented to provide a Root of Trust (RoT). In various embodiments, a firmware component management (FCM) operation, described in greater detail herein, may be implemented to include one or more trusted Advanced Calling Interface (ACI) operations. In various embodiments, a RoT based upon an EC 210 may be used in the performance of one or more ACI operations to update a Non-Volatile Memory Express (NVMe) boot partition (BP) with a trusted firmware component.

In various embodiments, one or more ACI operations may be performed to enhance the security of BIOS configuration through certificate-based authentication of a particular firmware component, as opposed to the use of traditional BIOS passwords. In various embodiments, one or more ACI operations may be performed to create a trusted capsule, familiar to those of skill in the art. In various embodiments, a trusted capsule may be implemented to contain measurements associated with an EC 210, or a Trusted Platform Module (TPM) 260, or a particular security processor, such as a Platform Security Processor (PSP), or Qualcomm® Security Processor (QSP), and so forth.

In various embodiments, one or more firmware component dispatcher (FCD) services may be used in the performance of one or more FCM operations. In various embodiments, one or more FCD services may be used in the performance of one or more FCM operations to dynamically identify a vulnerable firmware component stored in Serial Peripheral Interface (SPI) flash memory and suppress it from loading. In certain of these embodiments, one or more FCM operations may be performed to dynamically load a trusted firmware component from a payload provided by the system's operating system (OS) to update the previously-suppressed firmware component.

In various embodiments, one or more Dynamic Driver Services (DDS's) may be used in the performance of one or more FCM operations to request an Authenticated BIOS Interface (ABI) 638 for a particular ABI service 624. In various embodiments, a cloud-based ABI service 624 may be implemented to create a secure tunnel 634 once a target system has been authenticated. In various embodiments, the resulting secure tunnel 634 may then be used to pass a payload containing a requested service, or firmware component, or both.

In various embodiments, the secure tunnel 634 may be implemented to support the use of a trusted, secure open Secure Sockets Layer (SSL), or Transport Layer Security (TLS), session. In various embodiments, the SSL or TLS session may be used to securely provide the signed payload and its associated digital signatures and certificates to the authenticated system. In turn, the authenticated system may be implemented to perform one or more ACI operations during the trusted SSL, or TLS, session to provide the signed payload and its associated digital signatures and certificates it may have received to the authenticated system's associated EC 210.

In various embodiments, a DDS mode may be set at OS runtime 304 by setting a variable and payload base address. In various embodiments, one or more DDS's may be used at OS runtime 304 to create a Trusted Memory Region (TMR) on Intel® platforms, or within an NVMe BP on Qualcomm® platforms. In certain of these embodiments, one or more DDS's may likewise be used at OS runtime 304 to copy the payload into either the TMR or the NVMe BP.

In various embodiments, one or more DDS's may be implemented to determine the currently active DDS mode, and storage type, after the system reboots. In various embodiments, if DDS mode is enabled, payload contents are evaluated and the EC 210 RoT may be used to determine the validity of its associated digital certificate. In various embodiments, the validated payload may then be loaded into a Platform Configuration Register (PCR), familiar to those of skill in the art, such that it can be used across reboots. In various embodiments, the validated payload may be read from a BP if the validated payload's storage type is determined to be NVMe memory.

In various embodiments, one or more FCM operations may be performed to locate the validated payload in its memory storage location during system reboot. In various embodiments, one or more FCM operations may be performed to parse a located payload's associated eXtensible Mark-up Language (XML) file. In certain of these embodiments, the contents of parsed XML file may be used in the performance of one or more FCM operations for various types of dynamic actions.

In various embodiments, the dynamic action type contained in the XML file may be “remediation,” such as remediating a security vulnerability or an identified bug. If so, one or more FCM operations may be performed in various embodiments to obtain the validated payload from its memory storage location and extract its associated Firmware Volume (FV) and Extensible Firmware Interface (EFI) information. In certain of these embodiments, the extracted FV and EFI information may then be used in the performance of one or more FCM operations to override the Driver eXecution Environment (DXE) dispatch list to load the new firmware component and suppress its predecessor.

In various embodiments, the dynamic action type contained in the contents of a parsed XML file may be “automation.” If so, one or more FCM operations may be performed in various embodiments to obtain the validated payload from its memory storage location. In certain of these embodiments, one or more FCM operations may be performed to use the extracted validated payload to launch a Unified Extensible Firmware Interface (UEFI) shell, which may then be used to run one or more automation scripts.

In various embodiments, the dynamic action type contained in the contents of a parsed XML file may be “new feature.” If so, one or more FCM operations may be performed in various embodiments to obtain the validated payload from its memory storage location. In certain of these embodiments, one or more FCM operations may be performed to dispatch the new firmware component to determine its functionality.

Referring now to FIG. 6, a vendor CCE 622 may be implemented in various embodiments to provide certain vendor-related firmware components 624 and certain associated digital keys, such as key ‘2’ 626. In various embodiments, a CAS 602 may be implemented to include an ABI CCE 622. In various embodiments, the ABI CCE 622 may be implemented to provide certain ABI services 614 and certain associated keys, such as key ‘1’ 612. In various embodiments, key ‘1’ 616 or key ‘2’ 626, or both, may be implemented to include a hash, a digital key, a digital certificate, or a digital signature, or any other method for securing a payload.

In various embodiments, the vendor CCE 622 may be implemented to provide one or more firmware components 624, and an associated digital key ‘2’ 626 to the ABI CCE 612. In various embodiments, one or more FCM operations may be performed to establish a secure tunnel 634. In various embodiments, one or more FCM operations may be performed to use the secure tunnel 634 to pass key ‘1’ 656 to a particular system's EC 210 and key ‘2’ 646 to the system's TPM 260. In various embodiments, key ‘1’ 656 may be stored in the system's Platform Configuration Register (PCR), which is not shown in FIG. 6.

In various embodiments, key ‘1’ 656 may be used to validate key ‘2’ 646, which may be used in certain embodiments to ensure security in an associated trust zone 636. In various embodiments, key ‘2’ 626 may be sent with one or more associated firmware components 624 the ABI CCE 612. In various embodiments, the EC 210 may be implemented to verify that key ‘1’ 656 matches key ‘2’ 646.

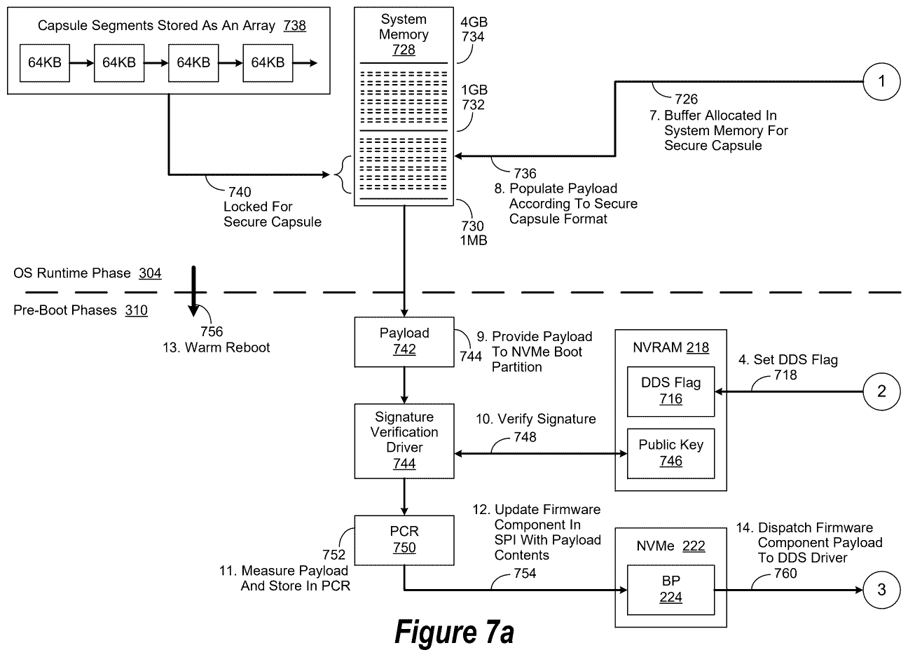

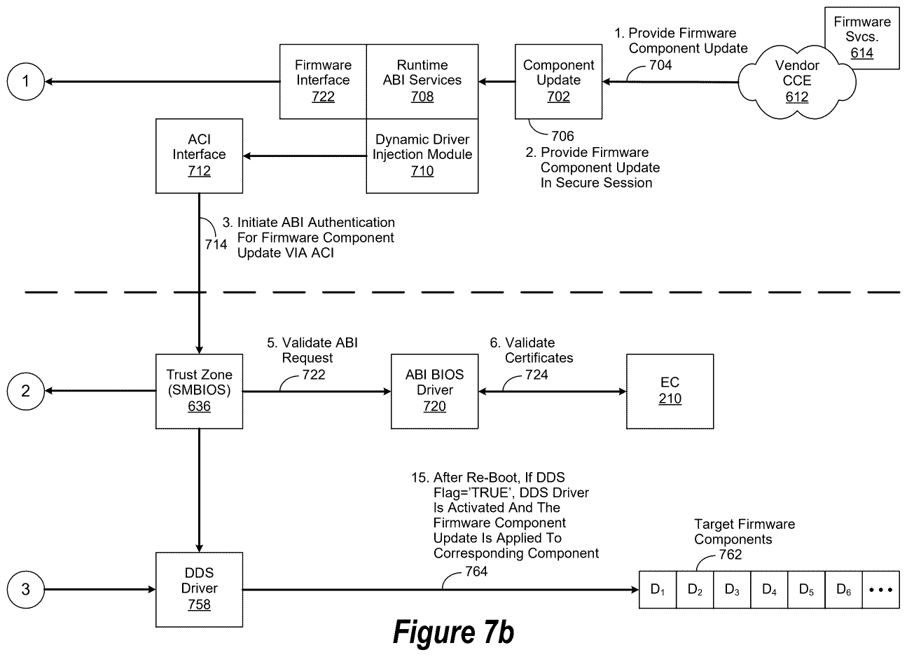

FIG. 7 is a simplified process flow diagram showing the performance of certain firmware component management (FCM) operations implemented in accordance with an embodiment of the invention to enable the provision of a persistent firmware component update. In various embodiments, one or more FCM operations, described in greater detail herein, may be performed to create a Trusted Memory Region (TMR) within the boot partition (BP) 224 of a Non-Volatile Memory Express (NVME) 222 flash memory device. In various embodiments, a TMR may be used in the performance of one or more FCM operations to use the system's embedded controller (EC) 210 as a Root of Trust (RoT), along with digital signature and certificate-based trust measurements, for storing certain driver services, or firmware components, or both, within the BP 224, and loading therefrom. In various embodiments, one or more FCM operations may be performed to enumerate an NVMe 222 BP 224 as a memory device that can be accessed early in the Pre Extensible Firmware Interface (EFI) Initialization (PEI) pre-boot phase immediately after Memory Reference Code (MRC) operations are performed by executing one or more Peripheral Component Interconnect Express (PCIe) Configuration Register operations.

Referring now to FIG. 7, a particular vendor's cloud computing environment (CCE) 612 may be implemented to provide certain firmware service 614, as described in greater detail herein. In various embodiments, the firmware services 614 provided may include the provision of certain firmware components, as likewise described in greater detail herein. In various embodiments, one or more FCM operations may be performed in step ‘1’ 704 to use the vendor CCE 612 to provide one or more firmware components 702. In various embodiments, a particular firmware component 702 may be provided in the form of a firmware component update.

In various embodiments, one or more FCM operations may be performed in step ‘2’ 706 to provide one or more firmware components 702 for use by certain Authenticated Basic Input/Output System (BIOS) Interface (ABI) services 708. In various embodiments, the one or more firmware components 702 may be provided to certain ABI services 708 during the system's Operating System (OS) runtime phase 304. In various embodiments, one or more of the ABI services 708 may be implemented to interface to a Dynamic Driver Injection Module (DDIM) 710. In various embodiments, the DDIM 710 may be implemented to provide a custom image containing one or more firmware components.

In various embodiments, the DDIM 710 may be implemented to interface to an Advanced Calling Interface (ACI) 712, described in greater detail herein. In various embodiments, one or more FCM operations may be performed in step ‘3’ 714 to use the ACI interface 712 to initiate ABI authentication of one or more firmware components. In various embodiments, one or more FCM operations may be performed to use the ACI interface 712 to store authenticated firmware components in a trusted memory zone 636, such as System Management Basic Input/Output System (SMBIOS).

In various embodiments, one or more FCM operations may be performed in step ‘4’ 718 to use the contents of the trusted memory zone 638 to set the mode of a Dynamic Driver Service (DDS) flag 716 within the system's Non-Volatile Random Access Memory (NVRAM) 218. In various embodiments, one or more FCM operations may be performed in step ‘5’ 722 to request an ABI BIOS driver 720 to validate one or more firmware components stored in the trusted memory zone 636. In various embodiments, one or more FCM operations may be performed in step ‘6’ 724 for the system's embedded controller (EC) 210 to be used by the ABI BIOS driver 724 to validate digital certificates associated with the one or more firmware components stored in the trusted memory zone 636.

In various embodiments, the runtime 304 ABI services 722 may be implemented to use a firmware interface 722 module in the performance of one or more FCM operations. In various embodiments, one or more FCM operations may be performed in step ‘7’ 726 to allocate a space within system memory 728 for buffering the contents of a secure capsule, familiar to those of skill in the art. As an example, the system may have a total of four Gigabytes (GB) 734 of system memory 728, with a portion between one Megabyte (MB) 730 and one GB 732 being allocated for the buffer.

In various embodiments, one or more FCM operations may be performed in step ‘8’ 736 to populate the allocated buffer space within system memory 728 with the payload contents of the secure capsule. In various embodiments, one or more FCM operations may be performed to populate the payload contents of the secure capsule in the allocated buffer space within system memory 728 in secure capsule format. In various embodiments, one or more FCM operations may be performed to segment the payload contents of the secure capsule into a plurality of capsule segments, which in certain embodiments may be stored in the form of an array 738. In various embodiments, one or more FCM operations may be performed to lock 740 the segmented contents of the secure capsule in the allocated buffer space within system memory 728.

In various embodiments, one or more FCM operations may be performed in step ‘9’ 744 to store the payload contents 742 of the secure capsule within the BP 224 of the system's NVMe 222 flash memory. In various embodiments, the system's NVRAM 218 may be implemented to store a public digital key 746. In various embodiments, one or more FCM operations may be performed in step ‘10’ 748 to use a signature verification driver 744 and a public digital key 746 stored in the system's NVRAM 218 to verify the digital signature of the payload contents 742.

In various embodiments, one or more FCM operations may be performed in step ‘11’ 752 to measure the payload contents 742 and store the resulting measurements within the system's Platform Configuration Register (PCR) 750. In various embodiments, one or more FCM operations may be performed in step ‘12’ 754 to update one or more firmware components currently stored in the system's Serial Peripheral Interface (SPI) flash memory with corresponding firmware component contained in payload contents 742. In various embodiments, one or more FCM operations may alternatively be performed in step ‘12’ 754 to update one or more firmware components currently stored in the BP 224 of the system's NVE 222 flash memory with corresponding firmware component contained in payload contents 742.

In various embodiments, one or more FCM operations may be performed in step ‘13’ 746 during the system's pre-boot phases 310 to perform a warm boot 756 of the system. After the warm boot 756 of the system has been performed in step ‘13’, one or more FCM operations may be performed in various embodiments, in step ‘14’ 760 to dispatch the contents of the payload 742 to a Dynamic Driver Service (DDS) driver 758. In various embodiments, one or more FCM operations may be performed to provide certain firmware components currently stored in the trust zone 636 to the DDS driver 758.

In various embodiments, one or more FCM operations may be performed in step ‘15’ after the warm boot 756 in step ‘13’ 756 has been completed to activate the DDS driver 758. In certain of these embodiments, firmware component updates are then applied to their currently-implemented, corresponding firmware components 762 if the DDS driver 758 Flag=‘TRUE’. Skilled practitioners of the art will recognize that many such embodiments are possible. Accordingly, the foregoing is not intended to limit the spirit, scope, or intent of the invention.

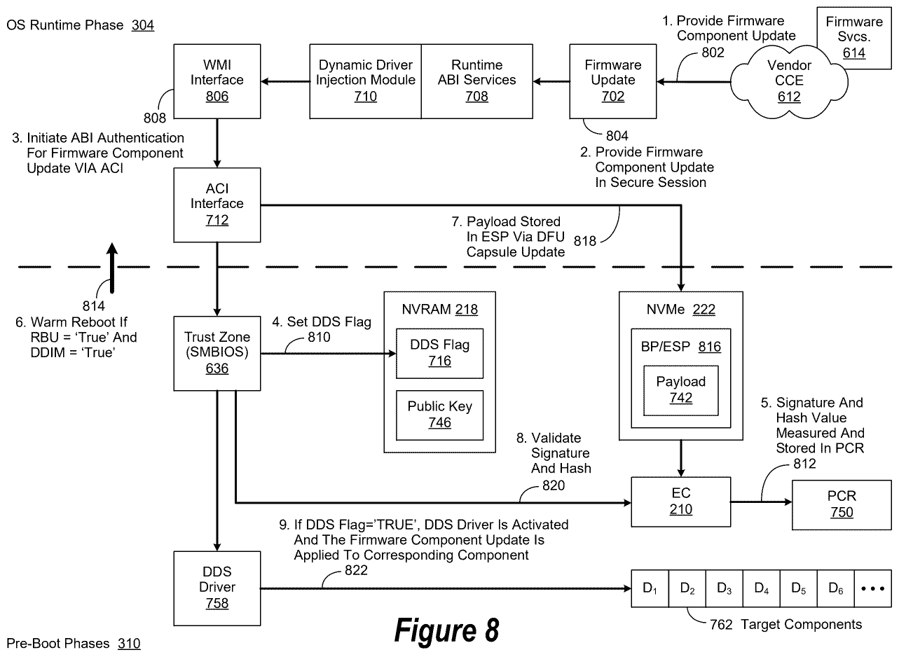

FIG. 8 is a simplified process flow diagram showing the performance of certain firmware component management (FCM) operations implemented in accordance with an embodiment of the invention to enable the provision of a non-persistent firmware component update In various embodiments, one or more firmware component management (FCM) operations, described in greater detail herein, may be performed to ensure that certain firmware components are persistently available for updates across system reboots, power cycles, and so forth. However, one or more FCM operations may be performed in various embodiments to enable non-persistent firmware component updates. In certain of these embodiments, performance of the one or more FCM operations may result in no updates remaining on the system to take effect across subsequent reboots. For example, a firmware component update may be implemented in certain embodiments to be performed once to recover an operational system state to enable it to boot to its Operating System (OS), after which the firmware component update is erased from memory.

In various embodiments, the performance of one or more FCM operations may allow individual firmware components to be securely updated. Likewise, the performance of one or more FCM operations in various embodiments may reduce the need for complete Serial Peripheral Interface (SPI) memory writes when only individual firmware components are updated. In various embodiments, the performance of one or more FCM operations may allow individual firmware components to be updated, regardless of the underlying System on Chip (SoC) architecture.

Referring now to FIG. 8, a particular vendor's cloud computing environment (CCE) 612 may be implemented to provide certain firmware service 614, as described in greater detail herein. In various embodiments, the firmware services 614 provided may include the provision of certain firmware components, as likewise described in greater detail herein. In various embodiments, one or more FCM operations may be performed in step ‘1’ 802 to use the vendor CCE 612 to provide one or more firmware components 702. In various embodiments, a particular firmware component 702 may be provided in the form of a firmware component update.

In various embodiments, one or more FCM operations may be performed in step ‘2’ 804 to provide one or more firmware components 702 for use by certain Authenticated Basic Input/Output System (BIOS) Interface (ABI) services 708. In various embodiments, the one or more firmware components 702 may be provided to certain ABI services 708 during the system's Operating System (OS) runtime phase 304. In various embodiments, one or more of the ABI services 708 may be implemented to interface to a Dynamic Driver Injection Module (DDIM) 710. In various embodiments, the DDIM 710 may be implemented to provide a custom image containing one or more firmware components.

In various embodiments, the DDIM 710 may be implemented to interface to a Windows Management Instrumentation (WMI) interface 806, familiar to skilled practitioners of the art. In various embodiments, the WMI interface 806 may be implemented to interface to an Advanced Calling Interface (ACI) 712, described in greater detail herein. In various embodiments, one or more FCM operations may be performed in step ‘3’ 808 to use the WMI interface 806 to initiate ABI authentication of one or more firmware components via the ACI interface 714. In various embodiments, one or more FCM operations may be performed to use the ACI interface 712 to store authenticated firmware components in a trusted memory zone 636, such as System Management Basic Input/Output System (SMBIOS).

In various embodiments, one or more FCM operations may be performed in step ‘4’ 810 to use the contents of the trusted memory zone 638 to set the mode of a Dynamic Driver Service (DDS) flag 716 within the system's Non-Volatile Random Access Memory (NVRAM) 218. In various embodiments, one or more FCM operations may be performed in step ‘5’ 812 to use the system's embedded controller (EC) 210 measure and store the digital signature and hash value stored in the system's Platform Configuration Register (PCR) 750. In various embodiments, one or more FCM operations may be performed in step ‘6’ 814 during the system's pre-boot phases 310 to perform a warm boot 814 of the system if the value of system's Remote BIOS Update (RBU) and the DDIM 710 is equal to ‘TRUE’.

After the warm boot 814 of the system has been performed in step ‘6’, one or more FCM operations may be performed in various embodiments, in step ‘7’ 818 to use the ACI interface 712 store the contents of the firmware component 702 payload in the system's Extensible Firmware Interface (EFI) System Partition (ESP) via Device Firmware Update (DFU). In various embodiments, one or more FCM operations may then be performed in step ‘8’ to use the system's EC 210 to validate the digital signature and hash of the firmware component payload stored in the system's trust zone 636. In various embodiments, one or more FCM operations may be performed in step ‘9’ to activate the DDS driver 758. In certain of these embodiments, firmware component updates are then applied to their currently-implemented, corresponding firmware components 762 if the DDS driver 758 Flag=‘TRUE’. Skilled practitioners of the art will recognize that many such embodiments are possible. Accordingly, the foregoing is not intended to limit the spirit, scope, or intent of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a firmware component management operation, the firmware component management operation managing updating of a firmware component of the distributed unified BIOS with an updated firmware component.

2. The method of claim 1, wherein:
the firmware component management operation uses a digital certificate to authenticate the updated firmware component prior to updating the firmware component with the updated firmware component.

3. The method of claim 1, wherein:
the firmware component management operation establishes a secure tunnel between the information handling system and a cloud computing environment; and,
the firmware component management operation uses the secure tunnel to obtain a firmware component payload for the information handling system.

4. The method of claim 3, wherein:
the firmware component payload includes a trusted firmware component; and,
the trusted firmware component is inserted into a boot path of the information handling system.

5. The method of claim 1, wherein:
the information handling system includes an embedded controller;
the firmware component management operation includes an advanced calling interface operation; and,
the embedded controller is used to perform the advanced calling interface operation.

6. The method of claim 5, wherein:
the information handing system includes a Non-Volatile Memory Express (NVMe) boot partition;
the advanced calling interface operation updates the NVMe boot partition with updated firmware component.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture; and,
performing a firmware component management operation, the firmware component management operation managing updating of a firmware component of the distributed unified BIOS with an updated firmware component.

8. The system of claim 7, wherein:
the firmware component management operation uses a digital certificate to authenticate the updated firmware component prior to updating the firmware component with the updated firmware component.

9. The system of claim 7, wherein:
the firmware component management operation establishes a secure tunnel between the information handling system and a cloud computing environment; and,
the firmware component management operation uses the secure tunnel to obtain a firmware component payload for the information handling system.

10. The system of claim 9, wherein:
the firmware component payload includes a trusted firmware component; and,
the trusted firmware component is inserted into a boot path of the information handling system.

11. The system of claim 7, wherein:
the information handling system includes an embedded controller;
the firmware component management operation includes an advanced calling interface operation; and,
the embedded controller is used to perform the advanced calling interface operation.

12. The system of claim 11, wherein:
the information handing system includes a Non-Volatile Memory Express (NVMe) boot partition;
the advanced calling interface operation updates the NVMe boot partition with updated firmware component.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture; and,
performing a firmware component management operation, the firmware component management operation managing updating of a firmware component of the distributed unified BIOS with an updated firmware component.

14. The non-transitory, computer-readable storage medium of claim 13, wherein:
the firmware component management operation uses a digital certificate to authenticate the updated firmware component prior to updating the firmware component with the updated firmware component.

15. The non-transitory, computer-readable storage medium of claim 13, wherein:
the firmware component management operation establishes a secure tunnel between the information handling system and a cloud computing environment; and,
the firmware component management operation uses the secure tunnel to obtain a firmware component payload for the information handling system.

16. The non-transitory, computer-readable storage medium of claim 15, wherein:
the firmware component payload includes a trusted firmware component; and, the trusted firmware component is inserted into a boot path of the information handling system.

17. The non-transitory, computer-readable storage medium of claim 13, wherein:
the information handling system includes an embedded controller;
the firmware component management operation includes an advanced calling interface operation; and,
the embedded controller is used to perform the advanced calling interface operation.

18. The non-transitory, computer-readable storage medium of claim 17, wherein:
the information handing system includes a Non-Volatile Memory Express (NVMe) boot partition;
the advanced calling interface operation updates the NVMe boot partition with updated firmware component.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
